(19) United States
(12) Patent Application Publication
(10) Pub. No.: US 2010/0012152 A1
(43) Pub. Date: Jan. 21, 2010

(54) SYSTEMS AND METHODS FOR TROCAR CLEANING

(76) Inventor: Adam J. Hansen, Tucson, AZ (US)

Correspondence Address: BAKER & ASSOCIATES PLLC, 470 EAST NINTH AVENUE, SALT LAKE CITY, UT, 84103, US

(21) Appl. No.: 12/176,472

(22) Filed: Jul. 21, 2008

(51) Int. Cl. B08B 9/035; A47L 7/00; B08B 9/053

(52) U.S. Cl. 134/21; 15/320; 15/104.061; 134/22.12

(57) ABSTRACT

One embodiment of the present invention relates to a trocar cleaning system including an elongated member and an irrigation device, a suction device, or a suction/irrigation device. The elongated member is designed to be inserted within a trocar. The elongated member includes a pliable wiper type member at the distal end to facilitate a radial plowing of debris within the trocar as the elongated member is inserted and removed. The elongated member also includes an internal channel coupled to a radial opening on the distal end and coupled to either an irrigation device or a suction device on the proximal end. The irrigation device may pressurize liquid through the internal channel and out a radial opening on the distal end of the elongated member so as wash the inside of the trocar. Likewise, the suction device may utilize the internal channel to create a suction force at the distal end of the elongated member.

### FIELD OF THE INVENTION

The invention generally relates to intraoperative surgical trocar cleaning. In particular, the present invention relates to a surgical cleaning system and method of operation.

### BACKGROUND OF THE INVENTION

Endoscopic surgery is a modern, minimally invasive surgery technique that includes performing the entire surgery through one or more small incisions rather than a large incision. The small incisions heal faster, thereby leading to expedited patient recovery. An endoscope extends through one of the small incisions to provide a visual image of the internal surgical field. Various mechanical surgical instruments may be attached to the endoscope and/or extended through the other small incisions to perform physical operations. A surgeon then utilizes the visual image provided by the endoscope in conjunction with the mechanical surgical instruments to perform the surgery without direct, open viewing of the internal region in which the operation is performed.

A trocar is a cylindrical device which may be inserted through a surgical incision to provide a channel through a body wall to the intended internal surgical region. A trocar may include a sharp distal end to assist with insertion into the “body cavity” or “surgical region”. A trocar may also include or be used in conjunction with various hollow cylindrical cannulae. The channel provided by the trocar and/or cannula is then used to insert the endoscope into the internal surgical field. One of the problems associated with this type of procedure is the obstruction or degradation of the image provided by the endoscope as a result of debris collected on the optical components of the endoscope. Tissue debris often collects on the endoscope during the insertion process as it is being advanced through the trocar. Unfortunately, the channel within the trocar often collects blood and tissue debris. As the endoscope is extended within the channel of the trocar, debris naturally collects onto the distal tip of the endoscope because of the relative dimensions of the channel and endoscope. The debris then obstructs the view of the internal surgical field and requires the surgical team to remove the endoscope, clean the debris from the endoscope, and reinsert the endoscope. This cleaning process is inefficient and may unnecessarily prolong surgery time.

Existing trocar cleaning devices have failed to efficiently and reliably clean the channel. Therefore, there is a need in the industry for a trocar cleaning system that efficiently and effectively cleans the internal channel of a trocar and overcomes the limitations of the prior art.

### SUMMARY OF THE INVENTION

The present invention relates to a surgical cleaning system. One embodiment of the present invention relates to a trocar cleaning system including an elongated member and an irrigation device, a suction device, or a suction/irrigation device. The elongated member is designed to be inserted within a trocar. The elongated member includes a pliable wiper type member at the distal end to facilitate a radial plowing of debris within the trocar as the elongated member is inserted and removed. The elongated member also includes an internal channel coupled to one or more radial openings on the distal end and coupled to either an irrigation device or a suction device on the proximal end. The irrigation device may pressurize liquid through the internal channel and out one or more radial openings on the distal end of the elongated member so as wash the inside of the trocar. Likewise, the suction device may utilize the internal channel to create a suction force at the distal end of the elongated member. The suction device and/or the irrigation device may be releasably coupled to the elongated member to facilitate interchangeability and modularity. A second embodiment of the present invention relates to a method of cleaning a trocar including pushing debris through the trocar, irrigating the internal channel of the trocar, and pulling the debris and irrigation fluid out of the trocar.

Embodiments of the present invention represent a significant advancement in the field. Existing trocar cleaning methods include laborious cleaning and reinsertion steps which extend surgical time and increase patient risk. Other cleaning systems include the utilization of absorption type materials which often become oversaturated and thereby fail to completely clean the trocar in a single pass. Still other techniques involve blind insertion of suction devices which may be over-inserted causing internal damage to the patient. The present invention overcomes the limitations of these and other cleaning systems by providing a reliable cleaning system that utilizes multiple cleaning operations on the internal channel of the trocar. These multiple cleaning operations include pushing debris, irrigating and pulling irrigated debris, and suctioning and extracting debris. In addition, the cleaning system incorporates a releasable coupler to facilitate utilizing available suction devices, irrigation devices, and/or suction/irrigation devices in conjunction with the elongated member.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a perspective view of a trocar cleaning system in accordance with one embodiment of the present invention;

FIG. 2 illustrates a perspective view of a trocar and trocar cleaning system in accordance with an alternative embodiment of the present invention, wherein the trocar cleaning system is positioned in a non-operational position with respect to the trocar;

FIG. 3 illustrates a perspective view of a trocar and trocar cleaning system in accordance with an alternative embodiment of the present invention, wherein the trocar cleaning system is positioned in an operational position with respect to the trocar;

FIG. 4 illustrates a detailed perspective view of the distal end of the trocar cleaning system illustrated in FIG. 2 in an exploded configuration;

FIG. 5 illustrates a detailed perspective view of the distal end of the trocar cleaning system illustrated in FIG. 2 in an assembled configuration;

FIG. 6 illustrates a detailed perspective view of an alternative distal end of a trocar cleaning system for use with narrow diameter trocar channels.

FIG. 7 illustrates a detailed perspective view of the proximal end of the trocar cleaning system illustrated in FIG. 2 in an assembled configuration; and

FIG. 8 illustrates an operational perspective view of the trocar cleaning system illustrated in FIG. 2 being inserted within a trocar in accordance with method embodiments of the present invention.

### DETAILED DESCRIPTION OF THE INVENTION

The present invention relates to a surgical cleaning system. One embodiment of the present invention relates to a trocar cleaning system including an elongated member and an irrigation device, a suction device, or a suction/irrigation device. The elongated member is designed to be inserted within a trocar. The elongated member includes a pliable wiper type member at the distal end to facilitate a radial plowing of debris within the trocar as the elongated member is inserted and removed. The elongated member also includes an internal channel coupled to one or more radial openings on the distal end and coupled to either an irrigation device or a suction device on the proximal end. The irrigation device may pressurize liquid through the internal channel and out one or more radial openings on the distal end of the elongated member so as to wash the inside of the trocar. Likewise, the suction device may utilize the internal channel to create a suction force at the distal end of the elongated member. The suction device and/or the irrigation device may be releasably coupled to the elongated member to facilitate interchangeability and modularity. A second embodiment of the present invention relates to a method of cleaning a trocar including pushing debris through the trocar, irrigating the internal channel of the trocar, and pulling the debris and irrigation fluid out of the trocar. Also, while embodiments are described in reference to a trocar cleaning system, it will be appreciated that the teachings of the present invention are applicable to other areas. For example, embodiments of the present invention may be utilized to clean cannulae and other hollow cylindrical regions to facilitate the insertion of sensitive surgical instruments.

The following terms are defined as follows:

### DEFINITIONS

trocar internal channel—broadly defined to include all hollow channels used to insert surgical instruments, including but not limited to trocars, cannulae, tubes, etc. The internal channel of a trocar may also be referred to as the lumen.

plow cleaning—a type of cleaning that includes plowing debris from a surface.

wipe cleaning—a type of cleaning that includes wiping debris from a surface.

pliable member—a member comprised of pliable material, including but not limited to rubber, plastic, sponge, etc. A pliable material is generally able to adjust its exterior shape in response to forces. For example, a circular rubber member may bend and/or compress as a result of being forced through an opening with a smaller cross sectional dimension.

Endoscopy surgery—broadly defined to include all minimally invasive surgical procedures, including but not limited to laparoscopy, thoracoscopy and arthroscopy.

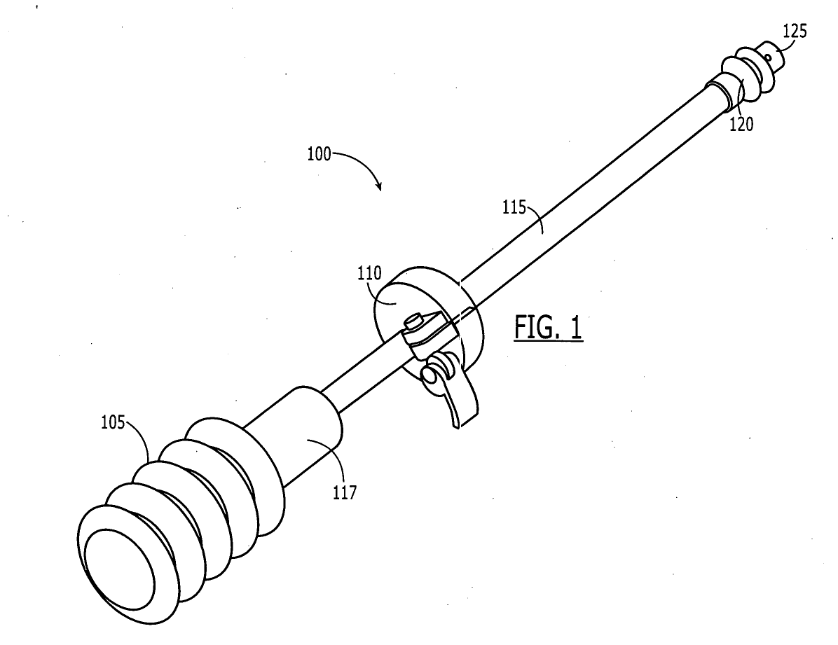

Reference is initially made to FIG. 1, which illustrates a perspective view of a trocar cleaning system, designated generally at 100. The system 100 may be used to clean the internal channel of a trocar before inserting a surgical instrument such as an endoscope. The illustrated system 100 includes an elongated member 115, a clamping member 110, and one of an irrigation device 105 and a suction device (not shown). The operation of the illustrated system 100 is substantially analogous to the alternative embodiments illustrated below and will therefore be described in combination with reference to FIG. 8. The system 100 is configured for interchangeability and modularity between the irrigation device 105 and a suction device (not shown) to allow for a variety of cleaning techniques. The elongated member 115 is a cylindrical rod-like structure which may be composed of a rigid metal material. It will be appreciated that the elongated member may alternatively be composed of other materials including but not limited to a rigid plastic material. The elongated member 115 includes a hollow internal channel (not visible externally) extending between the lengthwise ends. An expanded diameter region 117 is disposed on a proximal region of the elongated member to facilitate a gripping surface during operation and a coupling between the irrigation device 105 and the internal channel of the elongated member 115. The expanded diameter region 117 may be constructed by encircling a hollow member with a particular external diameter over a portion of the elongated member 115. The hollow member may be adhered to the elongated member 115 to prevent lengthwise translation. The elongated member 115 further includes a pliable member 120, a radial opening (not shown), and a cap 125 substantially disposed on the distal end of the elongated member 115. The clamping member 110 is releasably clamped onto elongated member 115 at a particular lengthwise position corresponding to the length of a particular trocar (not shown). The clamping member 110 is specifically placed by the user a particular distance from the distal end of the system 100 to correspond to the internal length of a particular trocar and prevent the system from being over inserted within a patient. Therefore, the clamping member 110 acts as an adjustable lengthwise translation stop by preventing the device from being inserted too far beyond a trocar and therefore within a patient.

The illustrated irrigation device 105 includes a hollow accordion bulb member which may be filled with fluid such as a saline solution. The internal chamber of the accordion bulb member is fluidly coupled with a lengthwise opening to the internal channel of elongated member 115. The lengthwise opening to the internal channel is disposed on the proximal side of the expanded diameter region 117. The fluid coupling between the accordion bulb member and the internal channel facilitates irrigation of fluids to the distal end of the elongated member. The fluid coupling may also include a mechanical coupling between the bulb member and the expanded diameter region 117 of the elongated member 115. In addition, the coupling between the irrigation device 105 and the elongated member 115 is releasable to facilitate separately filling the bulb member with fluids. Various releasable sealed couplings may be utilized between the irrigation device 105 and the elongated member 115, such as an o-ring type radial coupler (i.e. luer lock).

As described above, the system 100 is configured for modularity between an irrigation type device 105 and a suction device. It will be appreciated that the non-illustrated suction device may also include irrigation capabilities. Likewise, an irrigation device may also include suction capabilities. The irrigation device 105 may thereby be replaced by a suction device (not shown) coupled to the elongated member 115 via the same coupler as the irrigation device 105. The coupling between the suction device and the elongated member 115 includes a pressure coupling between an internal chamber of the suction device and a lengthwise opening to the internal channel of the elongated member 115 to facilitate a negative pressurization of the internal channel within the elongated member 115. Various commercial irrigation and suction devices may be utilized in conjunction with the system 100 by replacing their included long tube with the system 100.

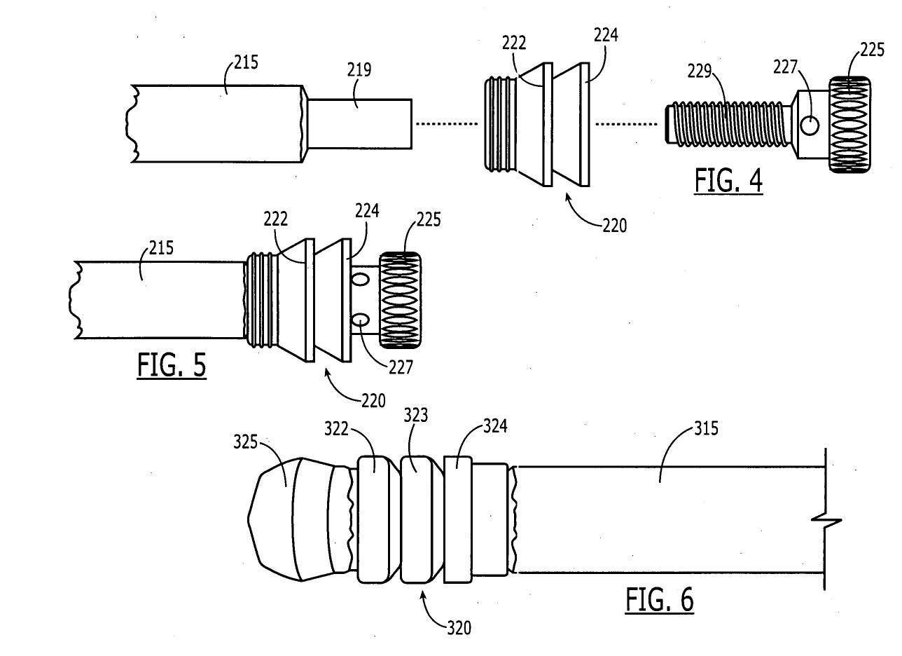

The distal region of the elongated member 115 includes a pliable member 120, a radial opening (not shown), and a cap 125. The cap 125 is coupled to the lengthwise distal end of the elongated member 115. The cap 125 lengthwise obstructs the internal channel of the elongated member 115. The radial opening is an external opening to the internal channel of the elongated member 115. The radial opening may be positioned on a portion of the cap 125 (see FIGS. 4-5) or on the elongated member 115 structure itself (see FIG. 6). The radial opening may include a plurality of radial openings oriented in various radial directions. The pliable member 120 includes at least one expanded diameter region equal to or greater than the internal diameter of a trocar channel. The pliable member 120 is positioned proximally with respect to the radial opening and the cap 125.

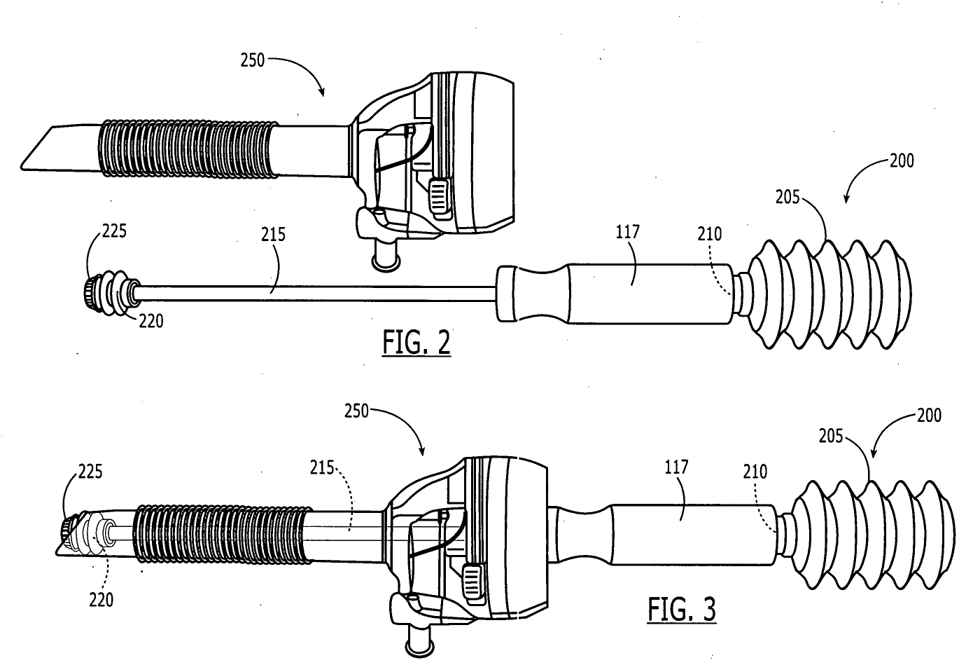

Reference is next made to FIGS. 2-3 which illustrate perspective views of an alternative trocar cleaning system, designated generally at 200. The alternative trocar system 200 is illustrated in a non-operational position adjacent to the trocar 250 in FIG. 3 and an operational position within the trocar 250 in FIG. 4. The illustrated trocar 250 is for reference purposes only, and it will be appreciated that the illustrated embodiment may be utilized with other trocars. The illustrated alternative system 200 is substantially analogous to the embodiment illustrated in FIG. 1 but does not include an additional releasable coupler 110 to accommodate certain types of suction devices. Rather, the system 200 includes a similar accordion bulb-type irrigation device 205 releasably coupled to an expanded region 217 of the elongated member 215 via a coupler 210. The expanded region 217 is likewise disposed on a proximal region of the elongated member 215 and shaped to facilitate a grip during operation. As described above, the lengthwise proximal positioning of the expanded region 217 corresponds to the length of the trocar 250 to prevent the system 200 from being over-inserted and thereby possibly harming the patient. The length and diameter of the elongated member 215 is specifically selected to correspond to the corresponding length and diameter of the internal channel of the illustrated trocar 250. The length of the exposed region of the elongated member 215 between the pliable member 220 and the expanded region 217 must be longer than the length of the internal trocar channel to permit the pliable member 220 to be routed through the internal trocar channel. Likewise, the diameter of the elongated member must be smaller than the diameter of the internal trocar channel to permit internal lengthwise translation.

The distal end of the elongated member 215 includes a cap 225, a radial opening 227 (see FIG. 4-5), and a pliable member 220. The cap 225 is disposed on the distal tip of the elongated member 215 and is utilized in this embodiment to lengthwise obstruct the internal channel of the elongated member 215. The cap 225 includes the radial opening 227 and thereby radially exposes the internal channel at the distal end of the elongated member 215. The pliable member 225 is positioned proximally on the elongated member 215 with respect to the cap 225 and radial opening 227. The illustrated pliable member 220 is a hollow circular rubber member with multiple expanded diameter regions. The hollow configuration of the pliable member 220 enables the pliable member to be circumferentially positioned over the elongated member 215. The positioning and configuration of the distal components will be further described with reference to FIGS. 4-6.

Reference is next made to FIGS. 4-5, which illustrate detailed perspective views of the distal end of the trocar cleaning system illustrated in FIG. 2. FIG. 4 and 5 illustrate exploded and assembled respective views of the distal components for the system 200 embodiment illustrated in FIGS. 2-3. The elongated member 215 may include a narrow region 219 at the distal end to facilitate the circumferential positioning and sandwich coupling of the pliable member 220 proximally from the cap 225. The narrow region 219 corresponds to the internal hollow diameter of the pliable member 220. The internal portion of the narrow region 219 may be threaded to facilitate coupling with the illustrated cap 225. The pliable member 220 includes two substantially conical expanded diameter regions 222, 224. The shape and diameter of the expanded diameter regions 222, 224 facilitates improved cleaning within the trocar channel. For example, the expanded diameter regions 222, 224 may be specifically sized larger than the internal diameter of the trocar channel so as to require deformation and ensure a 360 degree radial seal. A 360 degree radial seal will improve both wiping and plow type cleaning. Various alternative shapes and configurations may be utilized to accommodate different trocars and specific cleaning objectives. The cap 225 includes the radial opening 227 and a threaded region 229. The cap 225 is positioned on the distal end of the elongated member 215 to obstruct in a lengthwise manner the internal channel and/or direct the internal channel radially out the one or more radial openings 227. The threaded region 229 may be hollow to facilitate a lengthwise internal channel to the radial opening 227. The radial opening 227 may include a plurality of radial openings so as to direct fluid in equal radial regions. For example, four radial openings may be utilized and radially spaced 90 degrees from one another. In alternative embodiments, it will be appreciated that the illustrated pliable member 220 may be replaced by an absorbent member similarly attached and positioned. Therefore, a user may unscrew the cap 225, remove the pliable member 220 and dispose the absorbent member in its place to accommodate a particular situation or objective. Likewise, a combination absorbent and pliable member may be utilized. In an alternative non-illustrated embodiment, the cap may be integrated within the structure of the elongated member. For example, if the elongated member is composed of a rigid plastic material, the cap and the radial opening may be integrally composed on the distal tip without requiring any form of threaded cap.

Reference is next made to FIG. 6, which illustrates a detailed perspective view of an alternative distal end of a trocar cleaning system for use with narrow diameter trocar channels. The illustrated alternative distal end may be utilized in conjunction with a system designed for a smaller diameter internal trocar channel. The cap 325 may be a welded or swaged region of the elongated member 315 that obstructs in a lengthwise manner the internal channel. One or more radial openings (not shown) may be drilled directly into the elongated member 315. The pliable member 320 is circumferentially positioned on the elongated member 315 proximal from the cap 325. The illustrated pliable member 320 includes three expanded diameter regions 322, 323, 324. The shape and diameter of the illustrated expanded diameter regions 322, 323, 324 is specifically selected to accommodate a particular trocar internal channel. It is preferable to minimize the distance between the cap 325 and the pliable member 320 to minimize the risk associated for overextending the distal end into the surgical region.

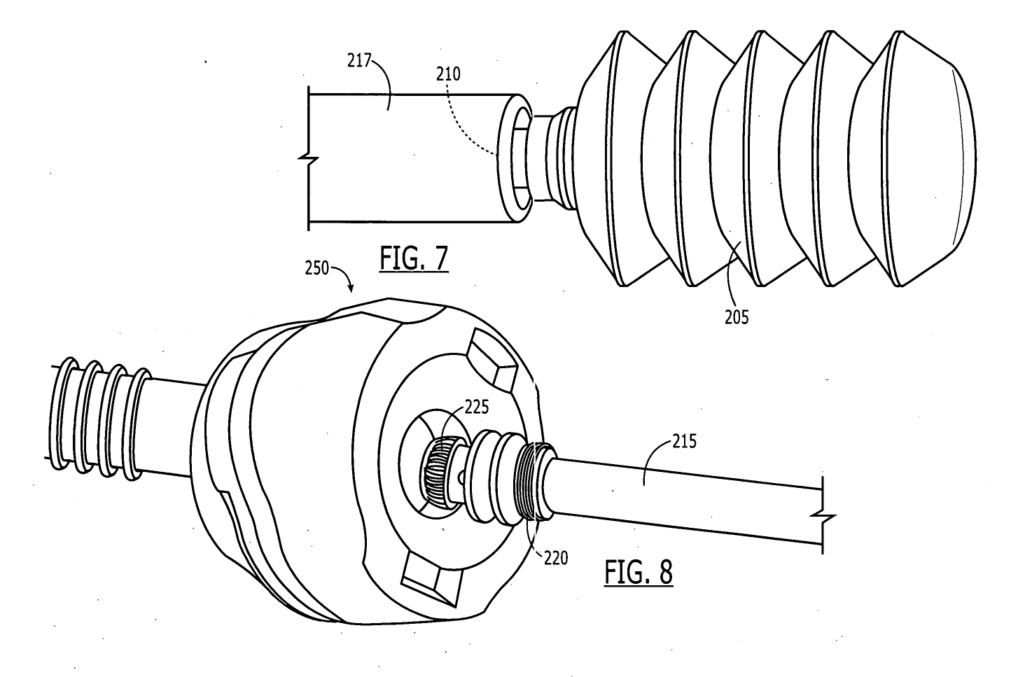

Reference is next made to FIG. 7, which illustrates a detailed perspective view of the proximal end of the trocar cleaning system illustrated in FIG. 2. The proximal end of the system 200 may be coupled to an irrigation system, a suction system, or combination irrigation/suction system. The illustrated irrigation device 205 is coupled to a lengthwise opening to the internal channel of the elongated member 215 within the expanded region 217 via a releasable coupler 210. The irrigation device 205 is a hollow accordion bulb member which may be separately filled with fluid for purposes of irrigation. The releasable coupler 210 may include a notched o-ring type coupler over which a portion of the irrigation device 205 may be translated to create a fluid coupling between the respective internal regions. The accordion shape of the bulb member 205 translates a lengthwise compression force to an expungement or pressurization of the liquid contained within the hollow internal regions. The fluid coupling with the internal channel of the elongated member 215 then routes the pressurized liquid to the distal end of the system 200. It will be appreciated that the bulb member 205 may also act as a suction device when the lengthwise compression force is released as a result of the materials' inherent bias towards the illustrated expanded configuration. The suction or negative pressurization within the bulb member 205 will be translated within the internal channel of the elongated member 215 and may further improve cleaning by suctioning additional debris. Various procedures and alternatively shaped bulb members may be utilized to further improve the combination of irrigation and suction.

Reference is next made to FIG. 8, which illustrates an operational perspective view of the trocar cleaning system illustrated in FIG. 2 being inserted within a trocar in accordance with method embodiments of the present invention. The distal end of the system 200 is inserted into the illustrated upper opening of the trocar 250. The upper opening of the trocar 250 is generally the portion that is external to the patient. The system 200 is extended within the trocar 250 such that the pliable member 220 extends beyond the trocar 250 and into an internal cavity (not shown). The expanded region 217 of the system 200 prevents the distal end from being inserted to a point which may cause damage to the patient. As described above, the shape, length and dimensions of the pliable member 220, cap 225, expanded member 217, and elongated member 215 correspond to the trocar 250. The effect of the pliable member 220 being routed through the trocar 250 is to push debris and/or liquid disposed on the internal surfaces of the trocar into the internal cavity. The pushing of debris results from the 360 degree radial seal between the pliable member 220 and the internal surface of the trocar channel. The pushing action may also be referred to as radially wiping and plowing the debris within the trocar. While the pliable member 220 is routed through the trocar 250, the irrigation, suction device, or irrigation/suction device (not shown) may be engaged to improve the amount of debris which is pushed within the internal cavity. For example, the bulb member may be depressed simultaneously as the elongated member 215 and pliable member 220 are routed through the trocar 250, causing the liquid within the bulb to be radially sprayed via the distal end, to the internal surfaces of the trocar 250. The effect of introducing liquid may dissolve debris and improve the wiping and plow type cleaning caused by the 360 degree radial seal of the pliable member 220 as it passes through the trocar 250. The pliable member 220 and elongated member 215 may then be lengthwise extracted from the trocar 250. The effect of the pliable member 220 being routed back out of the trocar 250 is to pull any additional debris and/or liquid disposed on the surfaces of the trocar. While the pliable member 220 is routed back out the trocar 250, a suction device and/or irrigation device may be used to improve the cleaning. For example, as the pliable member 220 is routed back out of the trocar 250, a suction or negative pressure may be generated at the distal end causing additional debris to be suctioned out of the trocar as the system 200 is removed. The process of inserting and removing the cleaning system 200 may be repeated or performed with particular time parameters to affect the cleaning of the internal channel of the trocar 250.

Various other embodiments have been contemplated, including combinations in whole or in part of the embodiments described above. Various additional components and or materials may be used in conjunction with embodiments of the present invention.

What is claimed is:

1. A trocar cleaning system comprising:
an elongated member having a distal end, a proximal end, and an internal channel extending therebetween;
a radial opening to the internal channel disposed on the distal end of the elongated member;
a pliable member disposed in substantial proximity to the distal end of the elongated member, wherein the pliable member is disposed proximally lengthwise from the radial opening on the elongated member, and wherein the pliable member includes an external diameter equal to or greater than the cross sectional diameter of an internal trocar channel;
a lengthwise opening to the internal channel disposed on the proximal end of the elongated member; and
one of an irrigation system and a suction system releasably coupled to the elongated member such that a seal is formed with the lengthwise opening, wherein the irrigation system is configured to force liquid out the radial opening of the elongated member, and wherein the suction system is configured to generate a suction force at the radial opening.

2. The trocar cleaning system of claim 1, wherein the length of the elongated member between the distal end and the proximal end is equal to or greater than the lengthwise length of the internal trocar channel, and wherein the diameter of the elongated member is less than the cross-sectional diameter of the internal trocar channel.

3. The trocar cleaning system of claim 1, wherein the distal end of the elongated member includes a lengthwise cap such that the only external distal opening to the internal channel is the radial opening.

4. The trocar cleaning system of claim 1, wherein the system includes a clamping member releasably coupled to the elongated member at a lengthwise location from the pliable member at least the length of the internal trocar channel, and wherein the diameter of expanded diameter region is greater than the diameter of the internal trocar channel.

5. The trocar cleaning system of claim 1, wherein the pliable member includes a plurality of independent radially extended regions.

6. The trocar cleaning system of claim 1, wherein the internal channel includes a common irrigation and suction channel, and wherein the radial opening is coupled to the common irrigation and suction channel.

7. The trocar cleaning system of claim 1, wherein the releasable coupler includes a mechanical clamp type coupler configured to circumferentially clamp one of the irrigation device and the suction device to the elongated member and the lengthwise opening.

8. The trocar cleaning system of claim 1, wherein the irrigation device includes an accordion bulb member with an internal cavity filled with a fluid.

9. A trocar cleaning system comprising:
an elongated member having a distal end, a proximal end, and an internal channel extending therebetween;
a radial opening to the internal channel disposed on the distal end of the elongated member;
a pliable member disposed in substantial proximity to the distal end of the elongated member, wherein the pliable member is disposed proximally lengthwise from the radial opening on the elongated member, and wherein the pliable member includes an external diameter equal to or greater than the cross sectional diameter of an internal trocar channel; and
an irrigation system releasably coupled to the proximal end of the elongated member, wherein the irrigation system is configured to force liquid through the internal channel and out the radial opening of the elongated member.

10. The trocar cleaning system of claim 9, wherein the distal end of the elongated member includes a lengthwise coupled cap such that the only external distal opening to the internal channel is the radial opening, and wherein the pliable member is sandwich coupled between the cap and the elongated member, and wherein the radial opening is disposed on the cap.

11. The trocar cleaning system of claim 10, wherein the cap is threadably coupled to the distal end of the elongated member

12. The trocar cleaning system of claim 9, wherein the system includes a clamping member releasably coupled to the elongated member at a lengthwise location from the pliable member at least the length of the internal trocar channel, and wherein the diameter of expanded diameter region is greater than the diameter of the internal trocar channel.

13. The trocar cleaning system of claim 9, wherein the pliable member includes a plurality of independent radially extended regions.

14. The trocar cleaning system of claim 9, wherein the internal channel includes a common irrigation and suction channel, and wherein the radial opening is coupled to the common irrigation and suction channel.

15. The trocar cleaning system of claim 9, wherein the releasable coupler includes a mechanical clamp type coupler configured to circumferentially clamp one of the irrigation device and the suction device to the elongated member and the lengthwise opening.

16. The trocar cleaning system of claim 9, wherein the irrigation device includes an accordion bulb member with an internal cavity filled with a fluid.

17. A method for cleaning an internal channel of a trocar comprising the acts of:
providing a trocar externally extending into an internal surgical region, wherein the trocar includes an internal channel with proximal and distal lengthwise openings and debris disposed within the internal channel;
providing a trocar cleaning system including an elongated member and an irrigation system;
inserting the distal end of elongated member of the trocar cleaning system through the internal channel of the trocar;
radially irrigating liquid within the internal channel of the trocar;
pushing debris within the internal channel into the internal surgical region;
removing the elongated member from the internal channel.

18. The method of claim 17, wherein the act of pushing debris within the internal channel into the internal surgical region includes radially plowing debris within the internal channel at the distal end of the elongated member while it is inserted through the internal channel.

19. The method of claim 17, wherein the act of radially irrigating liquid within the internal channel of the trocar includes depressing an accordion bulb coupled to the proximal end of the elongated coupler causing liquid to route through an internal channel of the elongated member and out a radial opening on the distal end of the elongated member.

20. The method of claim 17, wherein the method may further include the act of radially suctioning debris within the internal channel of the trocar into the elongated member.
